(19) United States
(12) Patent Application Publication
(10) Pub. No.: US 2003/0035013 A1
(43) Pub. Date: Feb. 20, 2003

(54) Personalized electronic cursor system and method of distributing the same

(76) Inventor: Edward M. Johnson, White Plains, NY (US)

Correspondence Address: OBERMAYER REBMANN MAXWELL & HIPPEL LLP, 1617 JOHN F KENNEDY BLVD, 19TH FLOOR, PHILIDELPHIA, PA, 19103, US

(21) Appl. No.: 10/123,070

(22) Filed: Apr. 12, 2002

Related U.S. Application Data
(60) Provisional application No. 60/283,711, filed on Apr. 13, 2001.

(51) Int. Cl. G09G 5/00

(52) U.S. Cl. 345/856

(57) ABSTRACT

A system for permitting an end user to place his or her picture into the cursor of a computer game. In one embodiment the system comprises an online system for personalizing a game comprising: a means for inputting a desired picture or representation to be used with the game; interface means for providing the end user with the ability to format the picture; a means for applying and controlling the picture on the cursor such that the picture moves with the cursor.

### CLAIM OF PRIORITY

This application claims priority of U.S. Ser. No. 60/283,711 filed Apr. 13, 2001 entitled Personalized Electronic Cursor System and Method of Distributing the Same.

### FIELD OF THE INVENTION

The present invention is directed to the field of customized computer cursors. In particular, the present invention is directed to an application for customizing a cursor for use, for example, in a child's computer game so that the child's picture or image can be shown within the cursor and thus appear to be part of the game or activity.

### BACKGROUND OF THE INVENTION

The toy and game industry is a highly lucrative and competitive industry in which a product usually becomes successful only if at has one or more unique and distinctive characteristics. Customizing or personalizing a product for a particular customer is generally well received by the public because it gives the impression that the product has not been mass-produced.

Customized or personalized products are especially welcomed by children as well as adults because they are viewed as being unique. To this end, books have been created in which the name of a specific child has been used for one of the characters in the book and the story line has been built around the specific child.

In recent years, electronic software programs (as used herein including electronic games, electronic books and other similar software products, educational software) have become increasingly popular and comprise a substantial portion of the toy industry.

While attempts have been made to personalize electronic software, these attempts have not been satisfactory because these programs are normally complex and are structured such that they are difficult to personalize. One possible desirable area would be to provide a customizable computer cursor in which a pre-selected picture or image could be inserted into the cursor. Heretofore, there has been no prior art system directed to customizable computer cursors for computer games and the like.

There are a number of U.S. patents that are directed to computer cursors. U.S. Pat. No. 6,067,085 is directed to a method and apparatus for providing visual queues on a display within a data processing system. An animated cross hair having a center that coincides with the cursor hot spot is displayed, wherein attention of a viewer of the animated cross hair is drawn to the cursor hot spot by the animated cross hair.

U.S. Pat. No. 5,850,210 is directed to a computer display pointing device for controlling a display cursor. The computer display pointing device includes a physical location pointer for pointing to physical locations. The computer display pointing device further includes a device for generating physical location signals useful for recording and correlating cursor locations corresponding to physical locations pointed by the physical location pointer. In a preferred embodiment, the physical location pointer is an arrow shaped pointer for pointing to the physical location. In yet another preferred embodiment, the physical location pointer is an unfolding arrow shaped pointer whereby the physical location pointer may be enfolded to function in a physical location and folded to function in a regular mode for controlling only the display cursor.

Finally, U.S. Pat. No. 6,201,947 is directed to a multi-purpose learning device having a picture book including a plurality of pages wherein the pages turn in a top to bottom hinged direction instead of a side-to-side direction, a memory unit having audio and video data stored therein, the memory unit being detachably connected to a touch board. A surface of the touch board is declined to a predetermined angle for enabling a user to easily position an electric pen perpendicular to the touch board. Each sheet of the picture book includes a blank page and a picture page and picture information corresponding to a picture on one of the pages is displayed on a host device, such as a television. A user moves the electric pen over a blank page which is positioned over the touch board and a cursor is displayed on the host device at a position corresponding to the position of the electronic pen over the blank page and touch board.

None of these patents, or any other prior art system, is directed to a system that can provide a customizable cursor that would allow, for example, a child to place his photo within the cursor. It would therefore be desirable to provide such a system whereby a child can view his picture, as he plays the game, preferably on the computer GUI cursor which control play.

It would be further desirable to provide a system which can be used to facilitate a customizable icon in which a pre-selected picture or image is inserted in the cursor. It would be further desirable to provide a system which can be used to allow a child to place his or her picture in a computer game in such a way that the child can participate in the game.

It would also be desirable to provide a system for uploading a child's picture on a computer game and the like in which the system can be used on global computer networks.

It would also be desirable to provide a system in which a plurality of embodiments and systems are provided for uploading the picture.

These and other objects of the present invention are described with reference to the following summary and detailed description

### SUMMARY OF THE INVENTION

The present invention is thus directed to a system and application for personalizing electronic software programs. More specifically, the present invention is directed to a system for personalizing computer program such as a computer game which makes use of a cursor which is movable across the screen with a mouse, a joy stick or various other means. The present invention is directed to a solution that recognizes the fact that many software programs have conventional cursors that can be suppressed and replaced with a new pre-selected pointing image, for example of a child who is intended to use the program or game. The invention thus provides users with the ability to add a plurality of pre-selected images such cartoon picture, picture of a child or family pet.

The present invention is also applicable to downloadable computer games or loadable computer games, educational systems and the like in which the pre-selected picture or image may uploaded pursuant to a pre-stored module. The present invention is similarly directed to a gaming or education system which may be accessed exclusively via a global computer network such as the Internet.

The present invention thus contemplates three embodiments. A first embodiment contemplates a system in which a pre-selected image can be sent away or electronically transferred for processing into the computer application such as a game and the application is returned to the end user with the picture or image incorporated therein. A second embodiment contemplates a system which resides on the hard drive of a computer and which includes an application or module in accordance with the present invention for permitting input of one or more pictures. In a related embodiment, the module may reside on the computer hard drive of an end user and facilitate the addition of a picture to the cursor during general usage. For example, a grandmother may generally desire to have a grandchild's photo on the cursor during general applications using the computer. In a final and third embodiment, the system comprises an online system in which the end user inputs a picture to play or learn via the Internet. In this embodiment, a web based end user interface is provided which facilitates the uploading of the picture.

In accordance with the present invention, the invention comprises a personalized system for allowing an end user to place a pre-selected image on a cursor comprising means for facilitating the input of the image into a computer cursor; and means for facilitating the movement of the cursor.

In a further embodiment, the invention is a system for affixing a pre-selected image on a cursor for use on a child's computer game comprising a means for sending the pre-selected image in a designated format to a processing system; means for formatting the image onto a computer cursor; and a means for saving the pre-selected image such that the image appears on the cursor when the game is in use.

In a still yet a further embodiment, the invention is an online system for personalizing a computer game comprising: means for inputting a pre-selected image to appear on the cursor; means for formatting the image, and means for applying and controlling the picture on the icon such that the picture moves with the cursor.

### BRIEF DESCRIPTION OF THE FIGURES

FIG. 1 is a perspective view of the first embodiment of the present invention in use.

FIG. 2 is a diagram of the operation of the first embodiment of the present invention.

FIG. 3 is a diagram of the second embodiment of the present invention.

FIGS. 4-6 are block diagram of a third online embodiment in accordance with the present invention.

FIG. 7 is a user screen and inputs for a proposed online version of the invention.

### DETAILED DESCRIPTION OF THE INVENTION

The present invention is described with reference to the enclosed Figures wherein the same numbers are utilized where applicable. Broadly, the present invention is directed to apparatus and methods for enabling a pre-selected image or picture, such as that of a child end user, to be input into an educational software system or computer such that the picture or image appears on the cursor and thus appears to be graphically participating in the game.

While the present invention is being described in the context of a child's educational software product or game, it is to be appreciated that the teachings of the present invention are applicable to customizable cursor images in general and may be applicable to such non-limiting examples as online gambling, computer board games such as Monopoly, and a host of commercial applications. The present invention is also directed to applying a pre-selected picture to a computer cursor, generally, such that the pre-selected image or picture appears on the cursor for general use of computer. It is also to be appreciated that while the present invention will be described in the context of a child's picture, that the teachings of the present invention are applicable to a multitude of other pictures and images such as a religious symbol or family pet.

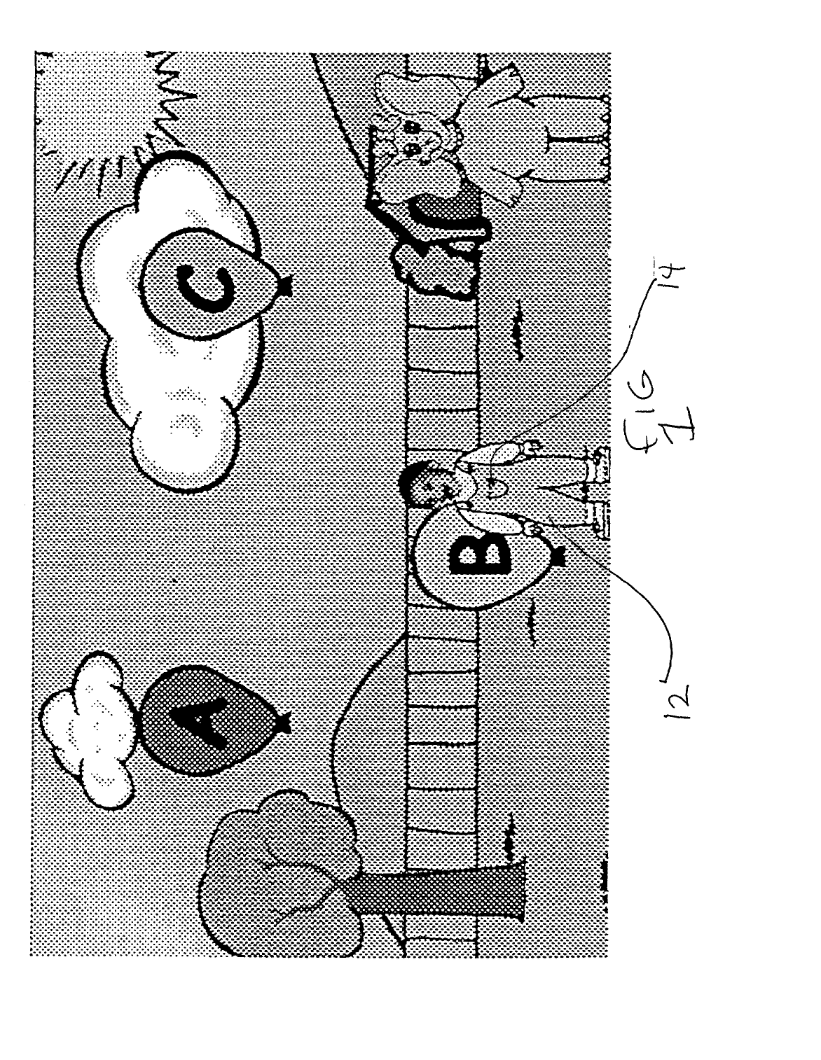

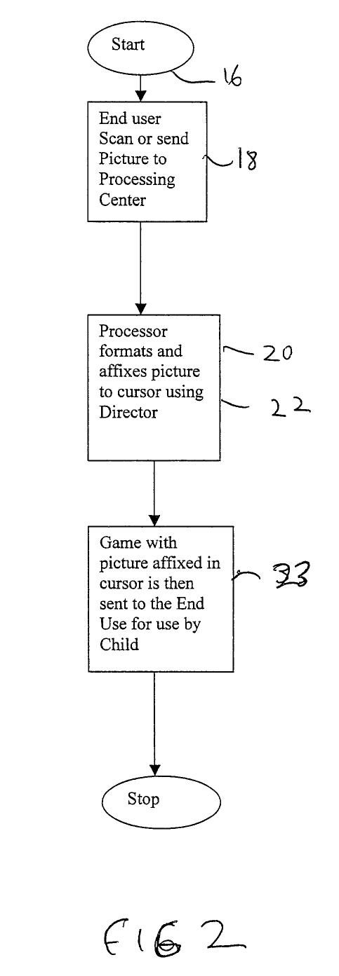

Referring to FIGS. 1 and 2, in a first embodiment, the present invention is directed to systems for uploading and utilizing a pre-selected end user picture within a computer game, and most particularly in an end user application incorporating a GUI cursor. As noted above, cursors are applicable with most popular computer systems, particularly those that incorporate a Graphical User Interface such as Microsoft Windows.

The present invention contemplates three embodiments. A first embodiment contemplates a system in which a picture or image is sent away for processing into the game or application by a remote processor and returned to the end user. A second embodiment contemplates systems which resides on the hard drive of a computer and which includes an application or module for inputting one or more picture. In a third embodiment, the system comprises an online system in which the end user inputs a picture. In this embodiment, an end user interface is provided with a means for uploading the picture.

Referring to FIG. 1, the game PNUTZ THE ELEPHANT at www.pnutz.com, the website of the present applicant of the present invention is illustrative of the first embodiment of the present invention. As shown in FIG. 1 and 2, the first embodiment 10 places a pre-selected picture 12 such as a child's picture within a computer cursor 14 for use in a computer game remotely.

In the first embodiment, the invention relies upon and uses a remote station incorporating an editing program such as Director® program made by Macromedia® and presently used to author games includes a track cursor feature that allows a game to determine the position and speed of a cursor independently of the actual shape or image associated with the cursor. While the present invention is described in the context of Director®, it is to be appreciated that other authoring systems may be used in the present invention.

In this embodiment, the invention utilizes a blank cursor feature that allows the inclusion of a standard image having predefined parameters (such as 8 bit/16×16 or 8 bit/32×32 pixels). In one embodiment, the regular cursor is reduced or suppressed and the desired image tracks the cursor thus giving the illusion to the user that it has replaced the cursor. Accordingly, the image of a child is thus provided in the game instead of the conventional cursor. The child end user who plays the game, when moving the cursor in the regular manner, thus sees his own image move instead of the cursor. This will provide more enjoyment to the child and give him a feeling of personal involvement in the game.

In a related embodiment, the cursor may be replaced by a composite image having two segments. One segment is a standardized segment which is designed by the game developer and may consist for example of an image of a child's body, a cartoon character vehicle, etc. The second segment comprises an image of a specific child's head. The two images are joined or superimposed so that the child's head appears on the body. The two segments are then moved together across a screen in the same manner as a conventional cursor.

The critical feature of the first embodiment, then, is that the pre-selected image of the child or character to be uploaded is sent to a remote processing station, either by mail or electronically, to be processed.

The method of personalizing the game at the remote station is now described as follows as shown in FIG. 2 in the context of a child's picture. First, the game developer (or an intermediary) sells a program 16 to a customer which allows for a child's picture to be added to the cursor. The customer then provides an image 18 of the child who is the intended recipient of the game to a processor 20. The child's picture is then uploaded by the processor into the system using a program such as Director, formatted and then added to the cursor of the game 22.

As noted, this process can be facilitated via electronic mail if an electronic image is available. The processor scans the picture (where necessary) and then generates the cursor image from the child's image as discussed above. The personalized program is then sent or delivered to the customer 23.

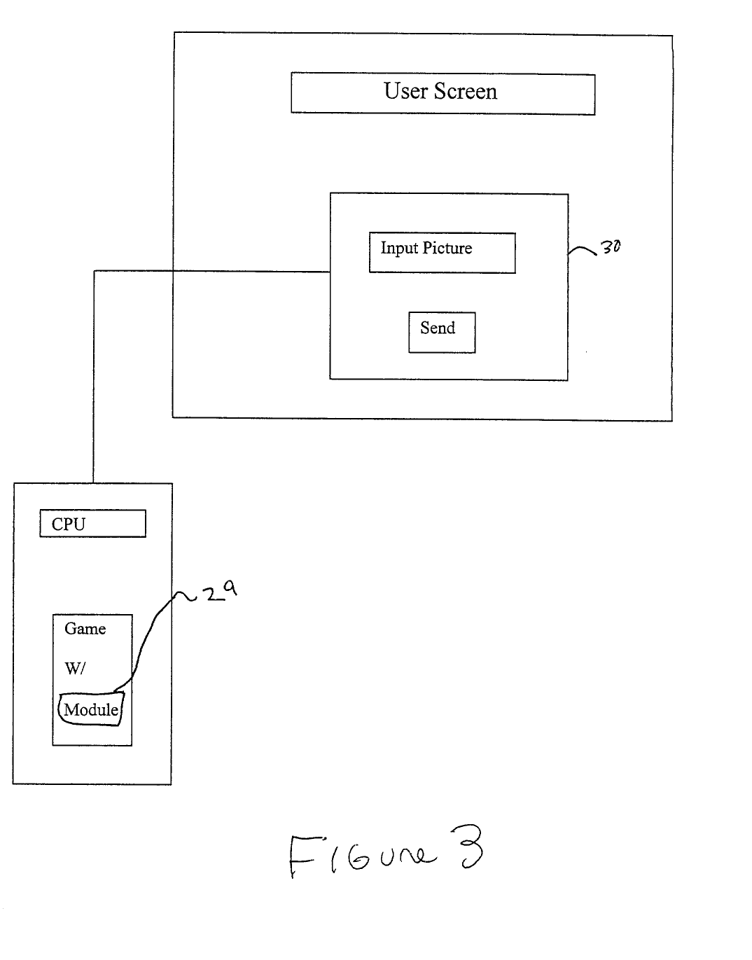

Referring to FIG. 3, in the second embodiment, the present invention comprises a system in which a system for uploading a picture or image and placing it within the game included and preloaded as a module 29 within the package containing the game. In this embodiment, the computer game, either sold as a physical package or downloaded off the Internet will include the module, which incorporates the editing features above, and which allows a picture to be uploaded and added to the cursor all on the end user workstation. Here, a user screen 30, associated with the game will enable the end user to upload a picture into the system for application into the cursor. In all of the embodiments of the invention, the picture may be displayed by itself or the child may be permitted to place the picture with a popular character or object such as a cartoon bus, boat or plane.

In a related embodiment, the system may be provided as a module which can be used by the end user to place pictures into the cursor on the Computer. In this general application, the system may comprise a module of the operating system such as Windows and permit as feature or functionality, the ability of a user to place a picture on the cursor. For example, a grandmother may wish to have the picture of a grandchild appear on the cursor. In this embodiment, the grandchild's picture will appear at the cursor position for all Windows based applications such Excel, MSWord, etc.

In the third embodiment, the present invention may be incorporated into a web based application. The Worldwide Web has a number of online computer games and websites which are accessible by children and adolescents. A number of popular websites including Cartoon Network, Nickelodeon and FoxKids provide real-time online games and application which incorporate the use of cursors. The third embodiment of the present invention contemplates allowing end users to upload pictures for incorporation into the cursor and game in both real time and non-real time via the Internet.

From a structural and operational standpoint, this embodiment comprises comprehensive internet based system including a central computer server 34 connected by a computer network 36 to remote end user stations 38. The central server connects to a database 150. End user stations 38 comprise a plurality of end users 16 and 18 linked via a transport medium 30.

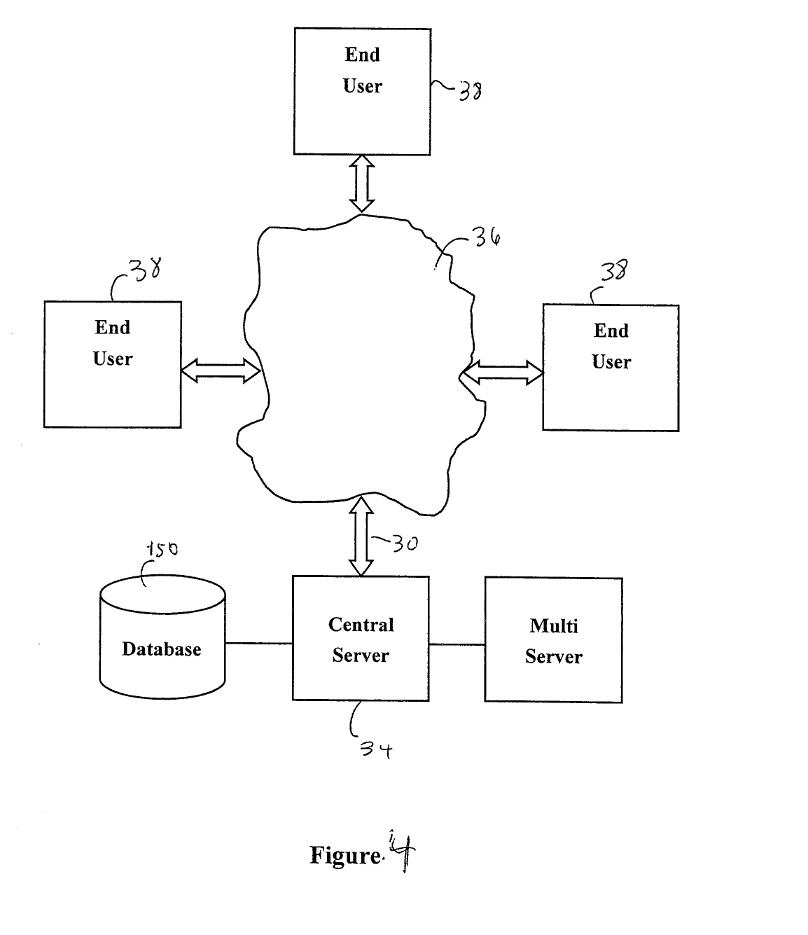

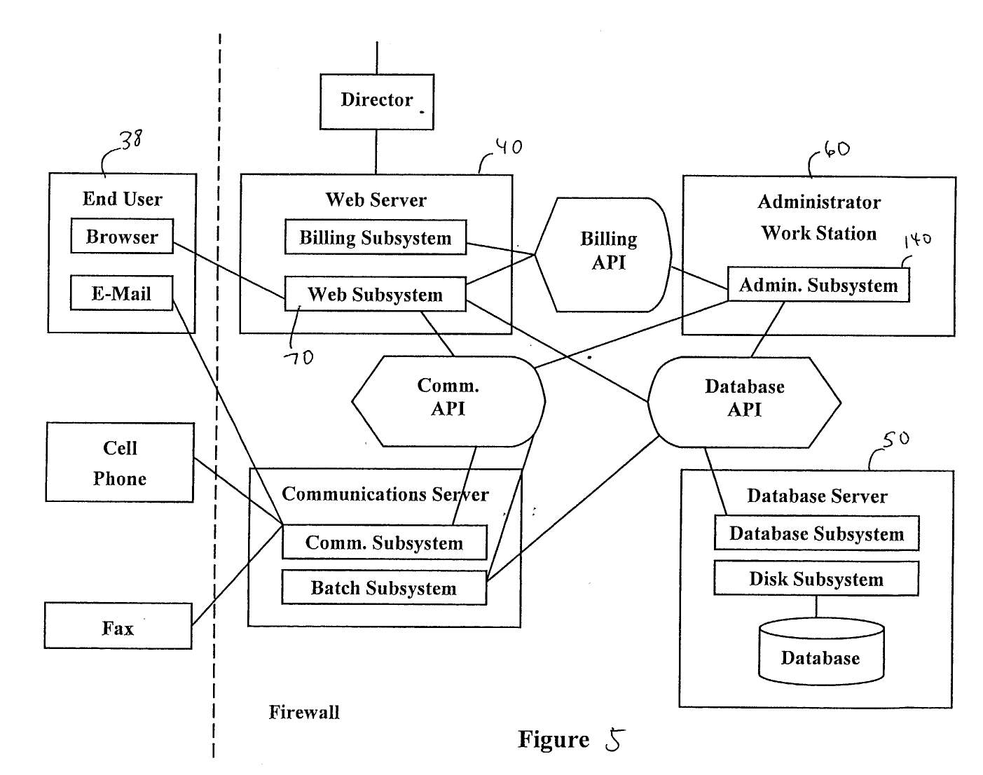

Referring to FIGS. 4 to 6, the central server and database systems of the present invention are now shown and described in greater detail. A local director 23 routes signals through the system to the various servers, to be described below, and to and through transport medium 30 to the end user. The system preferably includes two primary servers, a web server 40 and a database server 50 which may operate using such database platforms as SQL Server or Oracle. Hence, in one embodiment the SQL server may run SQL server database management software from Microsoft Corporation. Alternatively, the server can further comprise an Oracle database server. These are merely examples and do not limit the invention. The system further includes an administrative work station 60 or system which provides the administrative capabilities and monitoring for the system under the control of an administrative subsystem 140. The administrative work station 60 allows administrators or other operators to perform routine operations which affect the entire system.

A web subsystem 70 is responsible for all interactions with a web browser 80 in the end user devices and serves as the end user interface to the system. All interactions between the devices 38 and the database subsystem occur through the web subsystem 70. The web server 40 is the point of entry to the entire system. The web server 40 sends HTML or other high level computer language to the end user work stations 38, validates passwords, sends logging and transaction information to the database server 50, and performs logical operations, thus behaving as a transactional server.

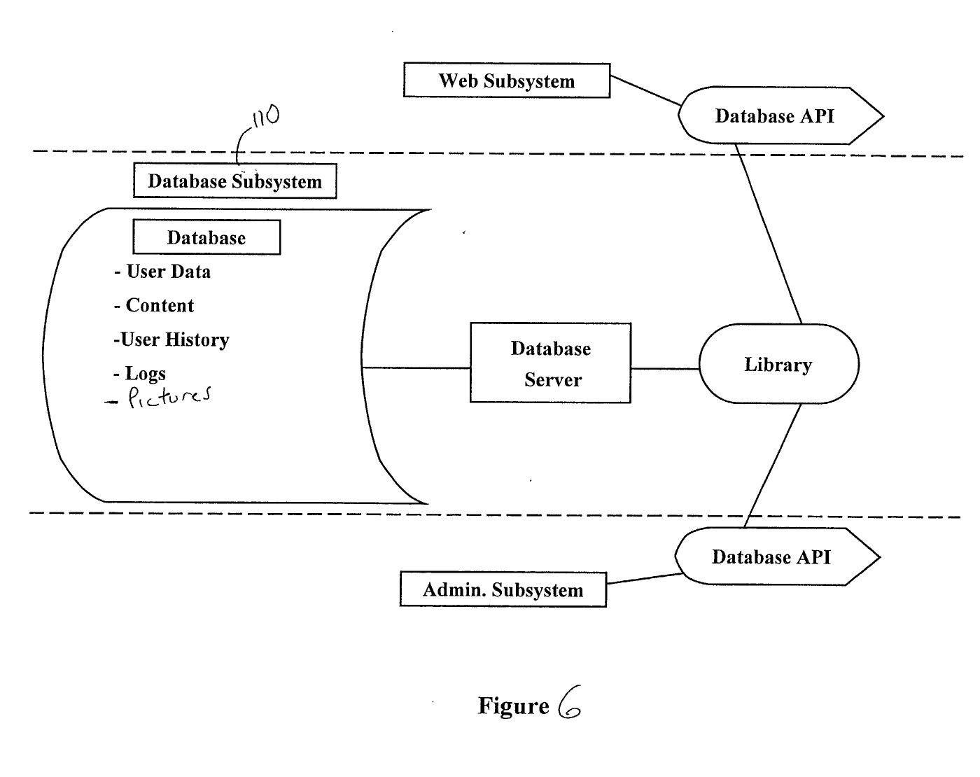

The administration subsystem 140 provides an interface for operators and managers of the system to modify the database, print reports, view system data and log user information. Referring to FIG. 6, the database server 50 which implements the database subsystem 110 of the present invention comprises a server that maintains all associated logging and transaction information for the system including the user pictures and content.

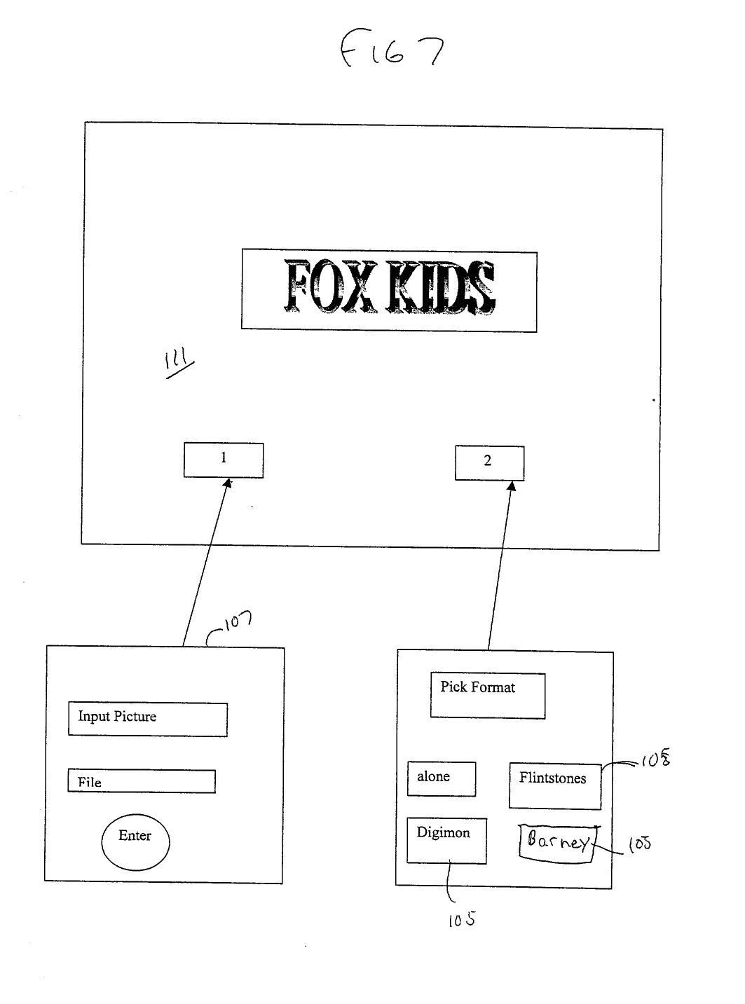

In view of the above Internet environment, an end user may enter a particular commercial website or game such as FoxKids as shown in FIG. 7. The system will provide an online module including an input screen whereby a child or end user can upload a pre-selected picture 107. The interface may provide the child or end user with a multitude of other options for use of the cursor 105. For example the child's face may appear on a cartoon body or the picture may appear with a popular character such as Barney, Digimon or the Flintstones. End user screen fed through web browser will enable the child to play the game in real time. The child can then see himself or herself or the pet or other familiar character participate in the game. The picture may comprise an animated gif or jpeg. In addition, it could also be a PNG (Portable Network Graphics) formatted image or bitmap (BMP) image, Quicktime movie, a Macromedia® Shockwave animation or Macromedia® Flash animation. The invention is in no way limited to the type of picture format and even covers formats not developed. This picture will then be inputted into the system, either online or in the software which is downloaded to the customer. It is to be noted that to work together, end users may be able to as parts of a group or club.

The present invention has been described with reference to the enclosed Figures. It is to be appreciated that other embodiments fulfill the spirit and scope of the present invention and that the true nature and scope of the present invention will be determined with reference to the claims appended hereto.

1. A personalized system for allowing an end user to place a pre-selected image on a computer cursor comprising:
means for facilitating the input of the image into a computer cursor; and
means for facilitating the movement of the cursor.

2. The system of claim 1 wherein the pre-selected image is that of a child.

3. A system for affixing a pre-selected image on a cursor for use on a child's computer game comprising:
means for sending the pre-selected image in a designated format to a processing system for application to the cursor of a child's computer game;
means for formatting the image onto a computer cursor; and
means for saving the pre-selected image such that the image appears on the cursor when the game is in use.

4. An online system for personalizing a computer game comprising:
user interface means for uploading a pre-selected image to appear on the cursor of the game when in use;
means for formatting the image; and
means for applying and controlling the image on the icon such that the image moves with the cursor when the online game is in use.
